(19) United States
(12) Patent Application Publication
(10) Pub. No.: US 2025/0132701 A1
(43) Pub. Date: Apr. 24, 2025

(54) MOTOR CONTROL METHOD

(71) Applicant: ZF Automotive UK Limited, Solihull (GB)

(72) Inventors: Vasile Coroban-Schramel, Solihull (GB); Dimitrios Kanellopoulos, Leamington Spa (GB)

(21) Appl. No.: 18/919,921

(22) Filed: Oct. 18, 2024

(30) Foreign Application Priority Data
Oct. 18, 2023 (GR) 20230100861

(51) Int. Cl. H02P 6/08; H02P 6/17

(52) U.S. Cl. CPC H02P 6/085; H02P 6/17

(57) ABSTRACT

A method of controlling an electric motor in an apparatus is disclosed. The apparatus comprises a motor having a rotor, a sensor which periodically generates estimates of the angular position of the rotor and an estimate of the velocity of the motor rotor, a microcontroller, and a communication network which connects the microcontroller and the position sensor. The method comprises the steps of periodically sending a request for rotor angular position across the communication network from the microcontroller to the sensor, receiving from the sensor across the communication network a response indicating the rotor angular position and the velocity of the rotor together with an ageing value indicative of the age of the rotor angular position value sent across the communication network, modifying at the microprocessor the received rotor angular position value using the ageing signal and the velocity signal to generate a modified angular position signal that is an estimate of the current rotor position; and generating, by the microcontroller, a set of control signals for the motor using the modified angular position signal.

### CROSS-REFERENCE TO RELATED APPLICATIONS

This application claims priority to Greek patent application Ser. No. 20/230,100861, filed Oct. 18, 2023, the disclosure of which is incorporated herein by reference in its entirety.

### TECHNICAL FIELD

This disclosure relates to a method of controlling a brushless electric motor and to a motor circuit including a motor, and in one exemplary arrangement, a brushless DC motor.

### BACKGROUND

Many types of electric motor are known, and also many different methods of controlling those motors. For applications where it is required to provide very precise control of the motor torque at low speeds it is common to provide a brushless motor known as a direct current DC motor. Such motors have a long operating life and high efficiency as they do not contain commutating brushes. The motor is controlled by applying a modulated signal to each motor phase. One common form or modulation is pulse width modulation (PWM) in which a fixed voltage is applied to a set of switches that are turned on and off in a controlled manner to apply a pulse width modulated waveform to each phase. The output of the switches is then connected to the phases of a brushless DC motor. The average voltage applied to each phase is set by the duty cycle of the waveform with the ON time of each energised phase being variable between 0 percent and 100 percent for each PWM cycle. The switches typically are arranged in an H-bridge pattern with one pair of switches for each phase, allowing the phase to at any time be connected to a positive DC supply or to a ground.

Because the motor does not have brushes it is important that the controller that generates the pulse width modulated waveforms receives information about the position of the motor rotor. In this way it can be assured that phases are energised and unenergized at the correct time that are dependent on the relative electrical position of the rotor and the stator, achieving an electronic commutation of the motor.

In a typical PWM method, the duty cycle is set at a fixed frequency and the voltage or current in the motor is adjusted to achieve the required motor behaviour. For precise control, the position of the motor and the values of the voltages or currents flowing in the motor are fed back to a PID type controller which varies the PWM signals so as to reduce an error between the actual motor behaviour and the demanded motor behaviour. Any errors in the position measurement or the voltage or current measurement will be fed back and can generate substantial noise in the motor. This may contain harmonics that are in the audible range of frequencies producing unwanted noise and may in the case of a motor in a steering system create unpleasant vibrations that can be felt at the steering wheel.

Motor rotor position can be measured relatively easily using a sensor such as a Hall effect type sensor that detects the relative position of a target magnet fixed to the motor rotor and a sensing head of the Hall effect sensor. The sensing head may have one or more discrete sensors that are offset from each other, and there may be more than one magnet fixed to the rotor at different locations. Such position sensors can be bought off the shelf, and the cost of the devices varies as a function of the level of performance they achieve. A higher performing, and typically more expensive, sensor will have a high resolution, a high accuracy and a low latency. Latency in this context means the delay between taking subsequent position measurements with a shorter delay providing lower latency.

Many sensors are also capable of both rotor position measurement and rotor velocity measurement. The later can be achieved where the sensor has a buffer to store both a current measurement and a previous measurement and a processing circuit that can process the difference between those measurements and the time elapsed between measurements to provide a measurement of speed. Often velocity values can be obtained from relatively low costs sensors as the additional functionality is entirely a software feature which can be employed using a low-capacity buffer and a few lines of code.

### SUMMARY

The disclosure herein is directed to ameliorating, at least partially, problems that arise when using relatively low-cost position sensors in a motor control circuit that requires a low level of motor speed or torque noise. Such a system may be especially suitable for use in automotive applications such as brake by wire, steer by wire or electric power steering-all of which require highly accurate control whilst keeping costs relatively low.

According to a first aspect the disclosure, a method of controlling an electric motor in an apparatus comprises:
a motor having a rotor,
a sensor which periodically generates estimates of an angular position of the rotor and an estimate of a velocity of the motor rotor,
a microcontroller, and
a communication network which connects the microcontroller and the position sensor,
the method comprising the steps of:
periodically sending a request for rotor position across the communication network from the microcontroller to the sensor;
receiving from the sensor across the communication network a response indicating the rotor position and the velocity of the rotor together with an ageing value indicative of the age of the rotor position value sent across the communication network,
modifying, at the microprocessor, the received rotor position value using the ageing signal and the velocity signal to generate a modified angular position signal that is an estimate of the current rotor position; and
generating by the microcontroller a set of control signals for the motor using the modified angular position signal.

The method step of modifying the rotor position value may further comprise adding to the angular position value a compensation value that is determined by combining the received velocity with the age of the signal such that the greater the age, the larger the magnitude of the compensating value for any given velocity.

The method may perform the modifying step using the following function:

Modified Angular position=Angular position+(age×velocity).

Where the angular position is the most recently received motor position from the position sensor;

Where age is indicative of time that has elapsed since the angular position value was calculated relative to when it was read out from the sensor to send to the microcontroller and

Where velocity is the velocity received from the position sensor.

The sensor may generate an ageing signal that is indicative of the elapsed since the sensor generated the angular position and velocity values and loading them to the microcontroller as a response to a request.

In one exemplary arrangement, the ageing signal may have a value indicative of the relative time within each cycle of the sensor at which a request is received from the microcontroller and the method may process this ageing signal to produce an ageing value indicative of the elapsed time using a transformation.

For example, the sensor may generate a count value Fsync that varies linearly from the start of each cycle to the end of a cycle, the sensor generating each estimate of angular position at a fixed value of the count value Fsync in each cycle and the sensor may then send to the microcontroller the value of the count value Fsync at the time that the values are loaded onto the communication network. This count value will be greater than the value at the time the angular position was calculated or may be less than that value if the request to read is received at a point in a sensor cycle before a new estimate for that cycle has been calculated.

For example, the count value may run from 0 to 31 and the angular position may be read at a count value of 22 in each sensor cycle. If the read request is received before the count value reaches 22 the sensor will send back to the microcontroller the most recent value of angular position which will be that determined in the last sensor cycle. If the request is received soon after the counter has reached 22, the value sent back will be the very recently calculated angular position from the current sensor cycle.

Where the period of the read requests is not an integer multiple of the period of sensor reads, the value of the count value Fsync will therefore differ from one read to the next, such that the age of values varies from one read to the next. The disclosure compensates for this variation in age allowing greater flexibility in the choice of sensor for a given application, and in one exemplary configuration, allowing sensors with relatively high latency to be used. By latency in this description, we mean the time between a rotor position being stored by the sensor and that value being loaded to the network following a read request. Unless the sensor and microcontroller are synchronised they will drift in and out of sync giving a variable latency.

The method may therefore comprise requesting the rotor position at a fixed time interval that is a non-integer multiple of the time interval between the position sensor generating sequential estimates of the angular position.

In one exemplary arrangement, the frequency of requesting rotor position and velocity is an integer multiple of the frequency of the motor control signals. A suitable motor control strategy that can be used that requires accurate rotor position information as an input is pulse width modulation PWM.

The method may comprise determining the modified position after a request has been sent to the signal using values returned in response to that request all before the next request is sent to the sensor. Alternatively, where it takes a long time to receive the values back over the communication network relative to the time between requests being made, the calculations may be made in the next period, i.e. after the next request has been sent. In each case, the calculation is made once the response to the request has been received and hence is made using the most up to date values available to the microprocessor.

For example, requests may be sent with a period of 200 microseconds and the PWM waveforms may have a period of 50 microseconds, and the sensor may generate new estimates of angular position with a period of between approximately 20 microseconds and 60 microseconds. This will depend on the design of the sensor where an off the shelf sensor is used.

The communication network may comprise a serial peripheral interface. The request sent by the microcontroller may comprise a word sent across the interface. This may be preceded by a wake-up signal being placed on the interface that wakes up the sensor.

The communication network may comprise one of a variety of other protocols, such as the fast synchronous serial interface SSC, an interface that uses the Single Edge Nibble transmission protocol SENT, or the integer integrated circuit I2C protocol and many others.

The sensor may transmit the angular position, the velocity and the ageing value as sequential words across the interface in response to receiving a request word from the microcontroller.

The sensor may generate the velocity value by processing the most recently determined angular position value with the immediately previous angular position value together with the time between the values being calculated.

The sensor may determine the time as a function of the frequency of calculation of angular position values. Where the time varies from period to period, the actual elapsed time may be used as determined from an internal clock of the sensor.

According to a second aspect the disclosure provides a motor circuit comprising:
a motor having a rotor,
a sensor which periodically generates estimates of the angular position of the rotor and an estimate of the velocity of the motor rotor,
a microcontroller, and
a communication network which connects the microcontroller and the position sensor,
in which the circuit is configured to carry out the steps of the method of the first aspect of the disclosure.

The motor may comprise a brushless motor.

The circuit may form a part of an automotive system.

### BRIEF DESCRIPTION OF THE DRAWINGS

There will now be described by way of example and exemplary arrangement of the present disclosure with reference to and as illustrated in the accompanying drawings of which:

FIG. 1 is a block diagram showing key function parts of an exemplary arrangement of a motor circuit according to the second aspect of the disclosure;

FIG. 2 is a timing diagram showing the relative start and end times of a series of microcontroller periods and a series of position sensor cycles;

FIG. 3 is a plot of velocity on the vertical axes against the periods and cycles of FIG. 2 showing the timing at which the sensor determines the rotor position and velocity values and the delay to a read request being received by the sensor, in which the actual velocity of the rotor is shown alongside the velocity that would be determined by the microcontroller if it was to process only received motor position signals;

FIG. 4 shows the flow of signals from the sensor to the microcontroller and generation of a modified angular position signal that is used to generate the PWM waveforms;

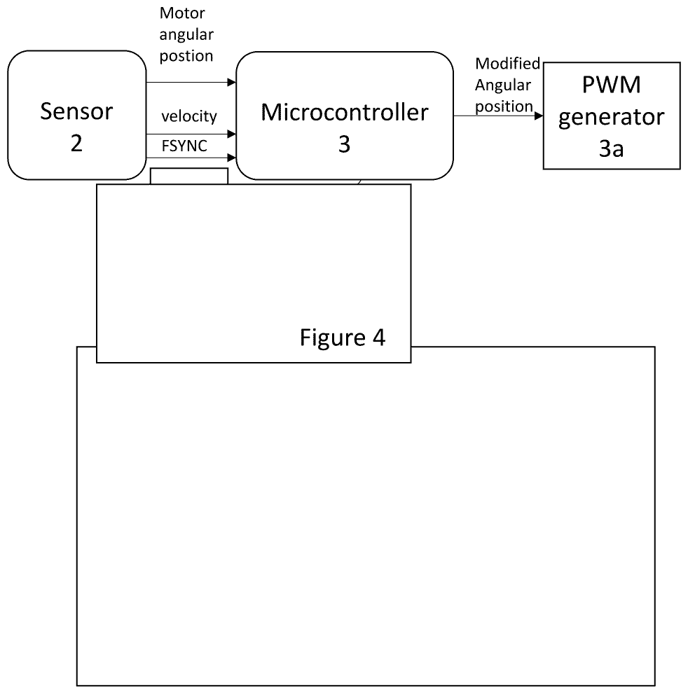

FIG. 5 is a flowchart of key method steps carried out by the circuit in accordance with the first aspect of the disclosure during each microcontroller;

FIG. 6 is a timing diagram showing from the top, the signals sent over the SPI bus over time, the triggers for the calculation of new PWM duty ratios, the timing of requesting reads and determining the modified rotor position values and the resulting PWM waveforms;

FIG. 7 shows an error in velocity of FIG. 3 that would occur if only unmodified rotor position signal values are used by the microcontroller over many more PWM periods and the relationship between the error and the value of a count value FSYNC at the sensor.

### DETAILED DESCRIPTION

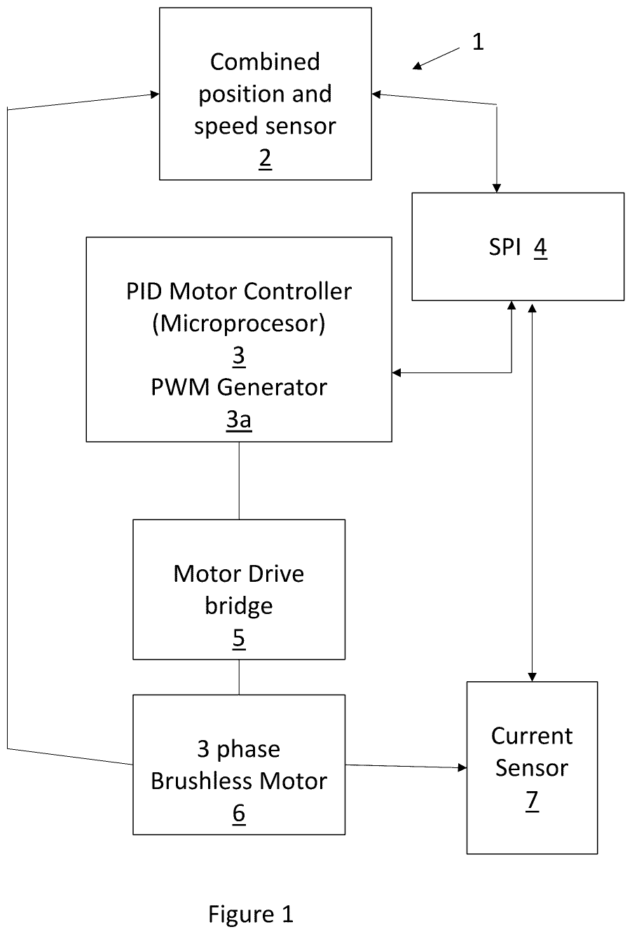

As shown in a FIG. 1 a motor circuit comprises a dc brushless motor 6 having 3 phases. Of course, the disclosure can be applied to motors having more than 3 phases, and to motors having more than one lane such as a two-lane motor where each lane has 3 phases or more. It may also be applied to brushless motors although being self commutating it is unusual to need position measurements to control such motors.

Although not shown in detail, the motor 6 comprises a stator and a rotor, the rotor having a set of permanent magnets buried a small distance below the surface of the rotor and arranged as alternating North and South poles. The stator in this example surrounds the rotor and has a cylindrical yoke with a set of pole teeth projecting inward from the yoke and terminating just above the surface of the rotor to define a small air gap. Coils of conductive wire are wrapped around the poles as three separate coil sets, each set defining a phase of the motor. The coils are all connected together in this example at a common point called a star point, the opposite ends of the coils being free to connect to a motor drive bridge as will be explained later.

The rotor and stator share a common axis about which the rotor can rotate freely when there is no current applied to the phase windings. When a voltage is applied to one or more of the phase windings, it causes current flow and in turn generates a magnetic field. This field will interact with the fields of the permanent magnets and depending on the relative positions of the rotor, the stator and the energised windings, may cause the rotor to rotate in one direction or the other or to remain locked in place.

The voltage is applied to the phases through a drive bridge 5 which is a conventional H-type bridge. This may have three pairs of switches, each pair comprising a top switch and a bottom switch connected in series between a power supply and a ground. A centre tap off from between the two serially connected switches is connected to the free end of a respective phase. By closing an upper switch and opening a lower one in a pair the respective phase will be connected to the supply voltage, less any voltage drop across the upper switch, and by closing the upper switch and opening the lower one the phase can be connected to ground.

The opening and closing of the switches of the drive bridge 5 is achieved by applying control signals to the gate of each switch. These control signals comprise pulse width modulated waveforms which are generated by a PWM generator. This in turn responds to a voltage demand signal output from a microcontroller. The PWM generator and microcontroller may be combined as a single processing circuit.

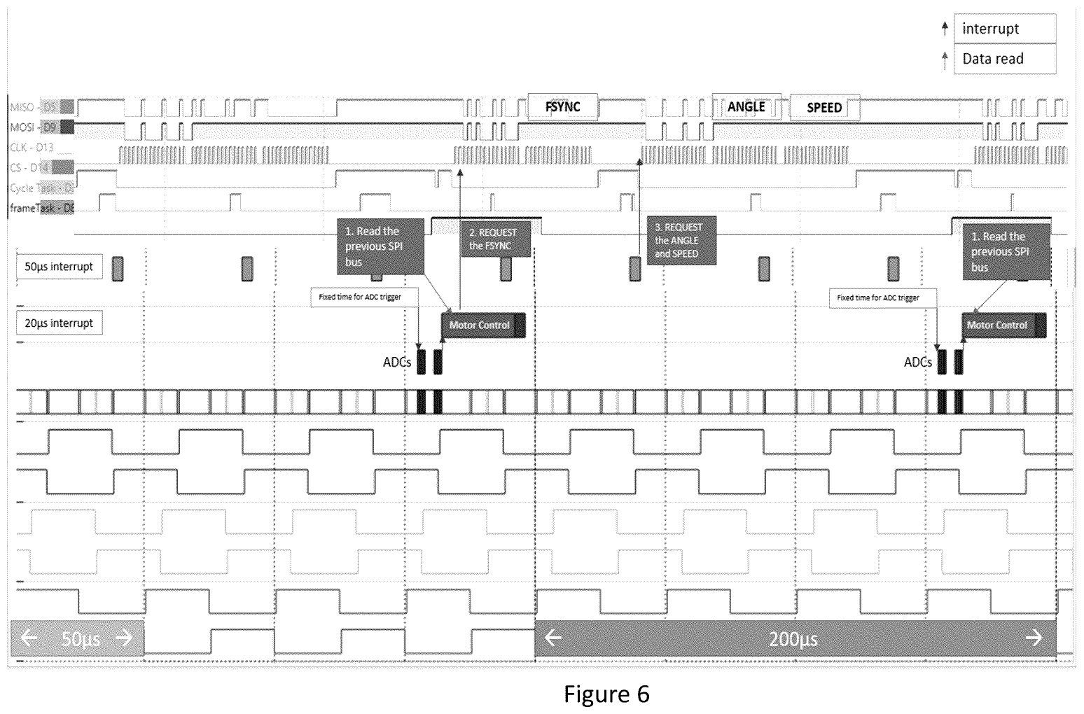

FIG. 6 shows three traces representing the PWM signals that are applied to each phase when the apparatus is in use. As can be seen, the three signals in this example have the same duty ratio and differ by being offset from one another. The PWM period chosen in this example is 50 microseconds.

The voltage demand signal is calculated once every 200 microseconds and passed to the PWM generator which updates the duty ratio of the PWM signals. The value chosen for the duty ratio depends on the torque or speed demanded from the motor, the motor properties and importantly the angular position of the rotor of the motor relative to the stator.

As shown in FIG. 1, the motor circuit 1 comprises a position sensor 2 that measures the angular position of the rotor. In one exemplary arrangement, the sensor 2 takes measurement repeatedly with an interval of approximately 42.6 microseconds. Specifically, the sensor 2 repeatedly initiates a read of the motor rotor angular position and saves this position value into a buffer of the sensor at a time 22/32ths of the way through each cycle. A counter FSYNC within the sensor 2 counts up from 0 at the start of a cycle until it reaches 31 and then loops back to zero to mark the start of the next cycle of calculations. The motor position value is therefore updated in the buffer at the time when the count is 21 in this example. Within the cycle, the sensor 2 also calculates the velocity of the rotor by calculating the difference between the position value stored in the current cycle and the one stored in the previous cycle and combining this with the known elapsed time of 42.6 microseconds between each value. This is also stored in the buffer.

The circuit 1 also includes a current sensor 7 that enables the controller 3 to be used within a feedback loop to drive the measured current towards an ideal current in the motor. In this example, the controller is a PID type controller using only PI terms, although the skilled person will understand that this is not to be considered limiting to the scope of the disclosure.

The current measurement and a motor rotor angular position are fed into the PI controller 3, along with an error value representative of the difference between the demanded current and the measured current. Signals are passed between the sensors and the microcontroller over the SPI interface 4.

It is important that the motor position is accurate when used by the PI controller 3. For example, it is important to use an as up-to-date a position measurement as possible. If old measurements are used, they will be erroneous as they will lag behind the actual position of a fast-moving rotor. The applicant has appreciated that the cycle frequency of the position measurements of 42.6 microseconds is both a substantial fraction of the PWM period but also the PWM period is a non-integer multiple of the sensor frequency.

Therefore, the microcontroller will request the position measurement from the sensor at a set point in the PWM period-typically right at the start-but this may correspond to any time within the cycle of the sensor. At this time, the sensor may have just determined a new position measurement, for instance where the request coincides with the counter of the sensor being at 23 or 24 say, or may be just prior to that time, say at 20 or 21. In the first case the returned position will be very recent and thus relatively accurate, in the later it will be much older and less accurate. This will vary from request to request over time, giving a variable latency to the signal.

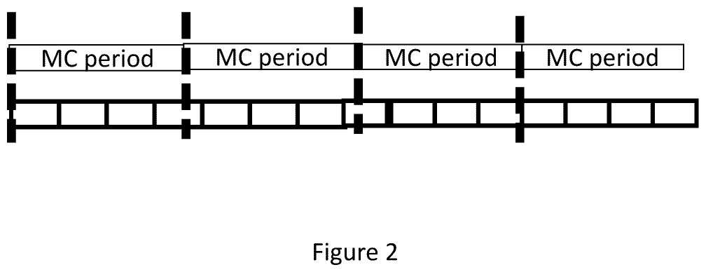

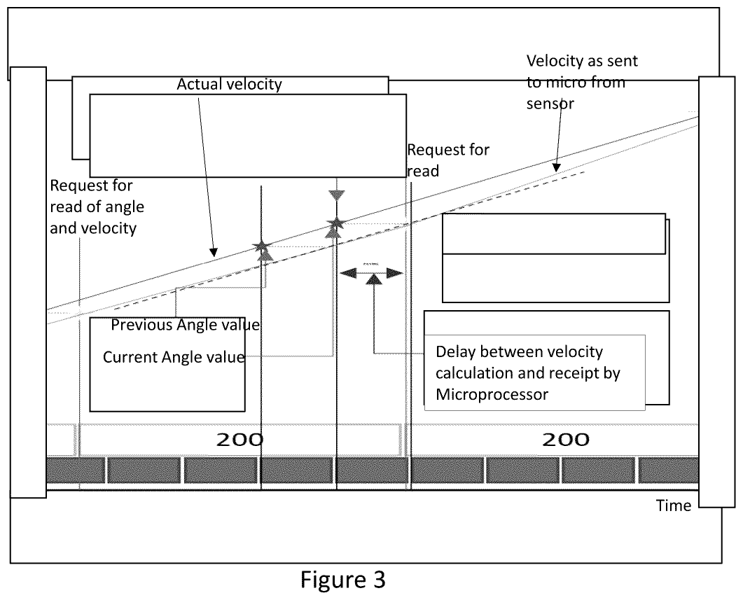

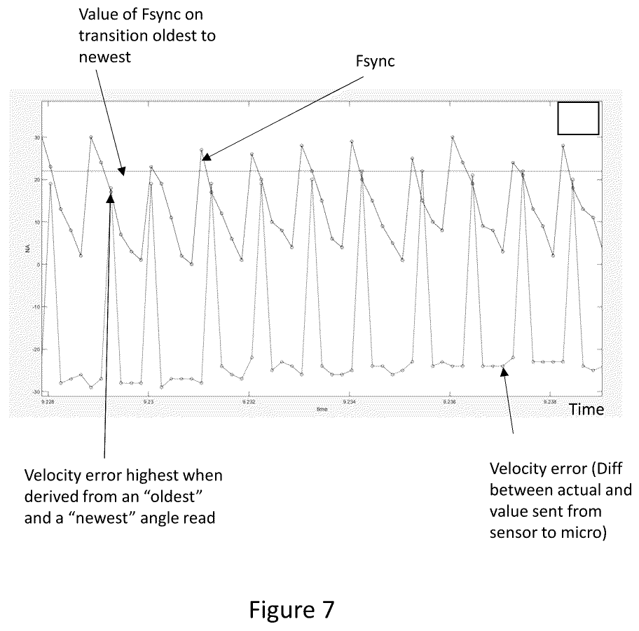

This drift can be seen in FIG. 2 and FIG. 3, and in FIG. 7 can be seen over many more PWM periods. As shown in FIG. 2, the Microcontroller period is 200 microseconds and below that is shown the sensor period of 42.6 microseconds. The former is a non-integer multiple of the later. In FIG. 2 the start of the first microcontroller period is aligned with the start of a sensor cycle, and then over the next three microcontroller periods the start moves through the sensor cycle until it returns to the start.

FIG. 3 shows the effect of this misalignment on the age of the rotor angular position measurement sent to the microcontroller in each microcontroller period. This figure also shows the timing at which measurements of position are made within the sensor and the timing of the read request in each microcontroller period. This delay between the latest measurement being and the read request vary from microcontroller period to the next, introduces an error which is not constant. If unchecked this produces noise in the control loop.

The microcontroller of FIG. 1 overcomes the effect of latency by requesting the most recently calculated motor rotor angular position and also requesting both the most recently calculated velocity and the counter value FSYNC when the read request is made, as opposed to the counter value when the measurement was last made, which in this example always takes place at the sample value of FSYNC due to the design of the sensor. The effect of the sensor determining the velocity using an old position and the latest one is for it to lag behind the actual velocity by a small fixed amount which can be compensated to an extent internally within the sensor, however it is not a noisy signal as it does not contain the variable latency being calculated internal to the sensor.

Once the signals have been received, the rotor angular position is modified to produce a modified position value using the following formula:

Modified Angular position=Motor Rotor Angular position+(Age×velocity).

Note that the value of counter value Fsync in this example has to undergo a transformation before being fed into the equation as the age value, so that a counter value Fsync of 22 corresponds to the shortest time delay and an age of zero and a counter value Fsync of 21 corresponds to the longest time delay and the highest age value. The transformation will require knowledge of the frequency at which position values are generated to generate an age value in the real time domain.

By taking account of the time since the last position measurement was made, and modifying it using a measurement of velocity, the effect of latency on the measurement of position can be ameliorated. There is an assumption that the velocity of the motor remains constant during the PWM period, which is reasonable where the periods are very short and the motor has a high intertia.

This position value is fed to the PI controller 3 which generates the motor demand voltages for the PWM generator 3a. This generates a set of motor control waveforms that are applied to the motor drive stage. The disclosure can be implemented using other motor control strategies but PWM is by far the most commonly used in a wide range of applications. By removing the variable latency the control signals were found to be far less noisy than the case where the modification is not made.

An exemplary process based on the use of a position sensor connected to a microcontroller over an SPI bus is shown in the timing diagram of FIG. 6. In this example the following parameters for the apparatus were defined:
PWM period of 50 microseconds
Microcontroller runs via an interrupt with a period of 200 microseconds

Read request for motor rotor position and velocity-at start of each Microcontroller period and approx. 100 microseconds before the PWM generator starts calculating PWM duty ratios for the next few PWM periods.

Read back of motor rotor position and velocity from the sensor-in first half of the Microcontroller period and before the PWM generator starts calculating.

PWM interrupt—timing signal for the start of each PWM period—every 50 microseconds.

Sensor latency—42.6 microseconds with no synchronisation to the microcontroller or PWM generator.

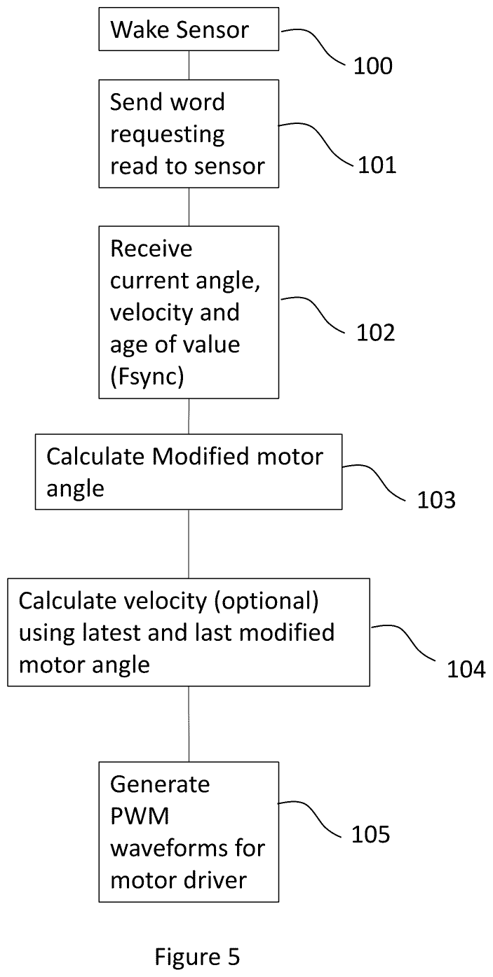

The method employed by the circuit is summarised in the following passages and is set out in the flow chart of FIG. 5.

At the start of each microcontroller period, a short trigger signal is applied to the CS line of the SPI bus 4 to wake 100 the position sensor. A word is then transmitted 101 from the microcontroller 2 to the sensor 4 on the MOSI line of the SPI which tells the sensor that a fresh set of measurements is requested. This always happens at the same fixed point within a microcontroller period. The sensor responds by loading three words to the SPI bus: the first gives the value of the counter FSYCNC at the time the position and velocity signals were read from the buffer, the second gives the value of the most recently determined motor rotor angular position (motor angle) which may be very new or up to one sensor period old, and the most recently determined value of the motor velocity. These values are read 102 from the SPI bus by the microcontroller and stored in a buffer of the microcontroller for use in the next microcontroller period.

Once the next microcontroller period starts, the microcontroller takes all three stored values from the previous period that are held in the buffer and calculates 103 the modified motor position. This calculated modified motor position is then stored back in the buffer for use by the PWM generator until the next time a modified motor position is determined, and the previous value overwritten. Optionally a motor velocity is calculated 104 using the most recent and last modified position signal values. The reason it cannot perform this calculation before the next read request is sent is simply due to the length of time of around 150 microseconds that is needed to receive the information from the sensor plus the time taken to wake the sensor and send the request and other factors.

Finally, the modified angular position signal value is used along with the measured current to determine the PWM duty cycles. The steps of FIG. 5 are then repeated, and this continues as long as the motor is operating.

1. A method of controlling an electric motor in an apparatus comprising:
a motor having a rotor,
a sensor which periodically generates estimates of the angular position of the rotor and an estimate of the velocity of the motor rotor,
a microcontroller, and
a communication network which connects the microcontroller and the position sensor,
the method comprising the steps of:
periodically sending a request for rotor angular position across the communication network from the microcontroller to the sensor;
receiving from the sensor across the communication network a response indicating the rotor angular position and the velocity of the motor rotor together with an ageing value indicative of an age of the rotor angular position value sent across the communication network,
modifying, at the microprocessor, the received rotor angular position value using the ageing signal and the velocity signal to generate a modified angular position signal that is an estimate of the current rotor position; and
generating, by the microcontroller, a set of control signals for the motor using the modified angular position signal.

2. A method of claim 1, wherein the step of modifying the rotor position value comprises adding to the rotor angular position value, a compensation value that is determined by combining the received velocity of the motor rotor with the ageing signal such that a greater the ageing value the larger the magnitude of the compensation value for any given velocity.

3. A method according to claim 2, further comprising modifying the rotor position value using the following function:
wherein Modified Angular position=Rotor Angular position+(age x of motor rotor velocity).

4. A method according to claim 1, wherein the sensor generates an ageing signal that is indicative of the elapsed time since the sensor generated rotor angular position and the rotor velocity values and loading the rotor angular position and rotor velocity values to the microcontroller as a response to a request.

5. A method according to claim 1, wherein the sensor generates a count value Fsync that varies linearly from a start of each cycle to an end of the cycle, the sensor generating each estimate of rotor angular position at a fixed value of the count value Fsync in each cycle and the sensor then sending to the microcontroller the count value Fsync at a time that the values are loaded onto the communication network.

6. A method according to claim 1, wherein the communication network comprises a serial peripheral interface and the request sent by the microcontroller comprises a word sent across the serial peripheral interface.

7. A method according to claim 6, wherein the sensor transmits the rotor angular position, the motor rotor velocity and the ageing values as sequential words across the serial peripheral interface in response to a receiving a request word from the microcontroller.

8. A method according to claim 1, wherein the sensor generates the motor rotor velocity value by processing the most recently determined rotor angular position value with the immediately previous rotor angular position value together with a time between the values being calculated.

9. A motor circuit comprising:
a motor having a rotor,
a sensor which periodically generates estimates of an angular position of the rotor and an estimate of a velocity of the motor rotor,
a microcontroller, and
a communication network which connects the microcontroller and the position sensor,
wherein the microcontroller is configured to generate a set of control signals for the motor using a modified angular position signal based on the angular position of the rotor detected by the sensor and using an ageing signal and the velocity of the motor rotor detected by the sensor.

10. The method according to claim 5, wherein the counter value Fsync will be greater than the counter value at the time the angular position value was calculated.

11. The method according to claim 5, wherein the counter value Fsync is less than the counter value if the request to read is received at a point in a sensor cycle before a new estimate for that sensor cycle has been calculated.
